(19) United States
(12) Patent Application Publication
(10) Pub. No.: US 2019/0228294 A1
(43) Pub. Date: Jul. 25, 2019

(54) METHOD AND SYSTEM FOR PROCESSING NEURAL NETWORK MODEL USING PLURALITY OF ELECTRONIC DEVICES

(71) Applicant: SAMSUNG ELECTRONICS CO., LTD., Suwon-si (KR)

(72) Inventor: Inchul HWANG, Suwon-si (KR)

(21) Appl. No.: 16/254,925

(22) Filed: Jan. 23, 2019

(30) Foreign Application Priority Data
Jan. 23, 2018 (KR) 10-2018-0008415

(51) Int. Cl. G06N 3/063; G06N 3/04

(52) U.S. Cl. CPC G06N 3/063; G06N 3/0454

(57) ABSTRACT

The disclosure relates to an artificial intelligence (AI) system for performing functions, such as recognition, determination, and the like, of a human being using a neural network model such as deep learning, and an application thereof.

A method, performed by a first electronic device, of processing a neural network model is provided. The method includes: acquiring an input value of the neural network model; processing at least one node included in a first group in the neural network model based on the input value; acquiring at least one value output from the first group by processing the at least one node included in the first group; identifying a second electronic device by which at least one node included in a second group in the neural network model is to be processed; and transmitting the at least one value output from the first group to the identified second electronic device.

### CROSS-REFERENCE TO RELATED APPLICATION

This application is based on and claims priority under 35 U.S.C. § 119 to Korean Patent Application No. 10-2018-0008415, filed on Jan. 23, 2018, in the Korean Intellectual Property Office, the disclosure of which is incorporated by reference herein in its entirety.

### BACKGROUND

### 1. Field

The disclosure relates to a method and a system for processing a neural network model using a plurality of electronic devices.

### 2. Description of Related Art

An artificial intelligence (AI) system may refer to a computer system for implementing human level intelligence. Unlike an existing rule based smart system, the AI system is a system that trains autonomously, decides, and becomes increasingly smarter. The more the AI system is used, the more the recognition rate of the AI system may improve and the AI system may more accurately understand a user preference, and thus, an existing rule based smart system is being gradually replaced by a deep learning based AI system.

AI technology includes machine learning (deep learning) and element technologies using the machine learning.

Machine learning may refer to an algorithm technology capable of classifying/learning features of input data autonomously, and element technologies are technologies capable of simulating functions of a human brain, such as recognition and determination, by facilitating a machine learning algorithm such as deep learning and include technical fields such as linguistic understanding, visual comprehension, inference/prediction, knowledge expression, and motion control.

Various fields to which AI technology is applied are linguistic understanding, which may refer to a technology to recognize and apply/process human language/characters and includes natural language processing, machine translation, dialog system, question and answer, voice recognition/synthesis, and the like, visual comprehension, which is a technology to recognize and process an object as a human vision does and includes object recognition, object tracking, image search, human recognition, scene understanding, space understanding, image enhancement, and the like, inference/prediction, which is a technology to determine information and perform logical inference and prediction and includes knowledge/probability-based inference, optimization prediction, preference-based planning, recommendation, and the like, knowledge expression, which is a technology to automatically process human experience information as knowledge data and includes knowledge construction (data generation/classification), knowledge management (data use), and the like, and motion control, which is a technology to control autonomous driving of a vehicle and a motion of a robot and includes movement control (navigation, collision avoidance, and driving), operation control (behavior control), and the like.

A terminal device may collect user-related data and transmit the collected data to a server, and the server may process the collected user-related data by using a neural network model. For example, the server may obtain an output value by inputting the data received from the terminal device as an input value of the neural network model.

However, the data collected by the terminal device and transmitted to the server may include security-sensitive information such as personal information of a user, data input by the user, and data related to the user's state sensed by a sensor. Therefore, data including sensitive information of the user may be exposed to a hacking attempt, data extortion, or data forgery in a data transmission process, and thus, ways of preventing and/or reducing hacking, data extortion, and data forgery are necessary.

### SUMMARY

Embodiments of the disclosure provide a system and a method capable of processing a neural network model while protecting important information using a plurality of electronic devices.

Additional aspects will be set forth in part in the description which follows and, in part, will be apparent from the description.

According to an embodiment of the disclosure, a method, performed by a first electronic device, of processing a neural network model includes: acquiring an input value of the neural network model; processing at least one node included in a first group in the neural network model based on the input value; acquiring at least one value output from the first group by processing the at least one node included in the first group; identifying a second electronic device by which at least one node included in a second group in the neural network model is to be processed; and transmitting the at least one value output from the first group to the identified second electronic device.

According to another embodiment of the disclosure, a method, performed by a second electronic device, of processing a neural network model includes: receiving, from a first electronic device, at least one value output from a first group in the neural network model which is obtained by processing at least one node included in the first group; acquiring at least one node included in a second group in the neural network model; and processing the at least one node included in the second group based on the received at least one value.

According to another embodiment of the disclosure, a first electronic device includes: a memory; a communication interface comprising communication circuitry; and a processor configured to control the first electronic device to: acquire an input value of a neural network model which is stored in the memory, process at least one node included in a first group in the neural network model based on the input value, acquire at least one value output from the first group by processing the at least one node included in the first group, identify a second electronic device by which at least one node included in a second group in the neural network model is to be processed, and control the communication interface to transmit the at least one value output from the first group to the identified second electronic device.

According to another embodiment of the disclosure, a second electronic device includes: a memory; a communication interface comprising communication circuitry; and a processor configured to control the communication interface to receive, from a first electronic device, at least one value output from a first group in a neural network model which is obtained by processing at least one node included in the first group, the processor further configured to control the second electronic device to: acquire, from the memory, at least one node included in a second group in the neural network model, and process the at least one node included in the second group, based on the received at least one value.

According to another embodiment of the disclosure, a non-transitory computer-readable recording medium has recorded thereon a computer-readable program for executing the methods of processing a neural network model.

### BRIEF DESCRIPTION OF THE DRAWINGS

The above and other aspects, features, and advantages of certain embodiments of the disclosure will be more apparent from the following detailed description, taken in conjunction with the accompanying drawings, in which:

FIG. 1 is a diagram illustrating an example neural network model according to an embodiment of the disclosure;

FIG. 2 is a diagram illustrating an example node included in a neural network model, according to an embodiment of the disclosure;

FIG. 3 is a diagram illustrating an example system for processing a neural network model using a plurality of electronic devices, according to an embodiment of the disclosure;

FIG. 4 is a block diagram illustrating an example first electronic device according to various embodiments of the disclosure;

FIG. 5 is a block diagram illustrating an example first electronic device according to various embodiments of the disclosure;

FIG. 6 is a block diagram illustrating an example second electronic device according to an embodiment of the disclosure;

FIG. 7 is a flowchart illustrating an example method of storing a neural network model in a plurality of electronic devices, according to an embodiment of the disclosure;

FIG. 8 is a flowchart illustrating an example method, performed by a plurality of electronic devices, of processing a neural network model, according to an embodiment of the disclosure;

FIG. 9 is a flowchart illustrating an example method, performed by a plurality of electronic devices, of processing a neural network model, according to an embodiment of the disclosure;

FIG. 10 is a block diagram illustrating an example processor included in the first electronic device, according to an embodiment of the disclosure;

FIG. 11 is a block diagram illustrating an example data training unit according to an embodiment of the disclosure;

FIG. 12 is a block diagram illustrating an example data recognizer according to an embodiment of the disclosure; and

FIG. 13 is a diagram illustrating an example of training and recognition of data according to linking between the first electronic device and the second electronic device, according to an embodiment of the disclosure.

### DETAILED DESCRIPTION

Hereinafter, various example embodiments of the disclosure will be described in greater detail with reference to the accompanying drawings. However, the disclosure may be embodied in many different forms and should not be understood as being limited to the embodiments of the disclosure set forth herein. In the drawings, parts irrelevant to the description may be omitted to clearly describe the disclosure, and like reference numerals denote like elements throughout the disclosure.

When it is described throughout the disclosure that a certain part is “connected” to another part, it should be understood that the certain part may be “directly connected” to another part or “electrically connected” to another part via another element. In addition, it will be understood that when a component “includes” an element, unless there is another description contrary thereto, it should be understood that the component does not exclude another element but may further include another element.

As used herein, the term “and/or” includes any and all combinations of one or more of the associated listed items. Expressions such as “at least one of,” when preceding a list of elements, modify the entire list of elements and do not modify the individual elements of the list.

Throughout the disclosure, the expression “at least one of a, b or c” indicates only a, only b, only c, both a and b, both a and c, both b and c, all of a, b, and c, or variations thereof.

Hereinafter, the disclosure will be described in greater detail with reference to the drawings.

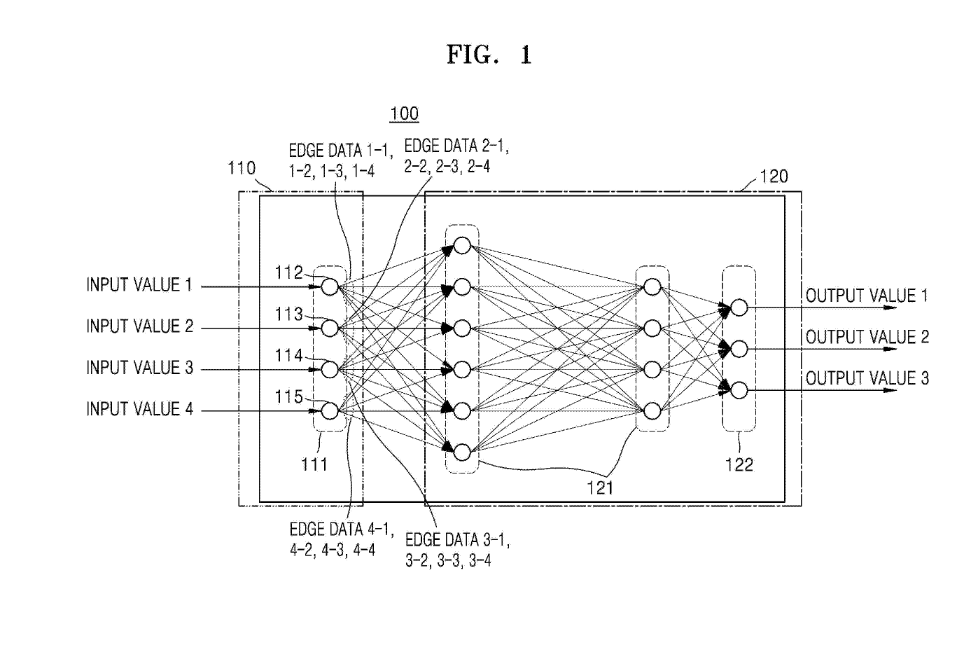

FIG. 1 is a diagram illustrating an example neural network model 100 according to an embodiment of the disclosure.

The neural network model 100 according to an embodiment of the disclosure may, for example, be a neural network algorithm model of simulating a method of recognizing a pattern by a brain of a human being. According to an embodiment of the disclosure, an electronic device may recognize a certain pattern from various types of data such as image, sound, character, and sequential data by using the neural network model 100.

According to an embodiment of the disclosure, the neural network model 100 may, for example, and without limitation, be a deep neural network (DNN), a convolutional neural network (CNN), a recurrent neural network (RNN), a bidirectional recurrent deep neural network (BRDNN), a restricted Boltzmann machine (RBM), a deep belief network (DBN), a deep Q-network, or the like. However, the neural network model 100 according to an embodiment of the disclosure is not limited thereto and may be one of various types of neural networks besides the examples described above.

Referring to FIG. 1, the neural network model 100 according to an embodiment of the disclosure may include at least one layer 111, 121, and 122, each including at least one node 112. For example, the neural network model 100 may include an input layer 111, an output layer 122, and at least one hidden layer 121.

According to an embodiment of the disclosure, nodes in each of the layers 111, 121, and 122 may be processed by inputting at least one input value to the input layer 111. For example, input values 1, 2, 3 and 4 may be input to respective nodes 112, 113, 114, and 115 in the input layer 111.

In addition, values output from nodes in each layer may be used as input value for a next layer. For example, certain values may be input to nodes in the at least one hidden layer 121 based on values obtained by processing the nodes 112, 113, 114, and 115 in the input layer 111. In addition, certain values may be input to nodes in the output layer 122 based on values obtained by processing the nodes in the at least one hidden layer 121. Values output from the output layer 122 may be output as an output value of the neural network model 100. For example, output values 1, 2 and 3 output from the output layer 122 may be output as an output value of the neural network model 100.

According to an embodiment of the disclosure, at least one edge data may be acquired from one node by applying at least one weight to one value output from the one node. The edge data may be acquired as many as the number of weights applied to the one value. Therefore, a value output from a node in a certain layer may be converted into at least one edge data and input to at least one node in a next layer. For example, by applying different weights to values output from the nodes 112, 113, 114, and 115, edge data 1-1, 1-2, 1-3 and 1-4, 2-1, 2-2, 2-3 and 2-4, 3-1, 3-2, 3-3 and 3-4, and 4-1, 4-2, 4-3 and 4-4 may be output and input to nodes in a next layer as illustrated in FIG. 1.

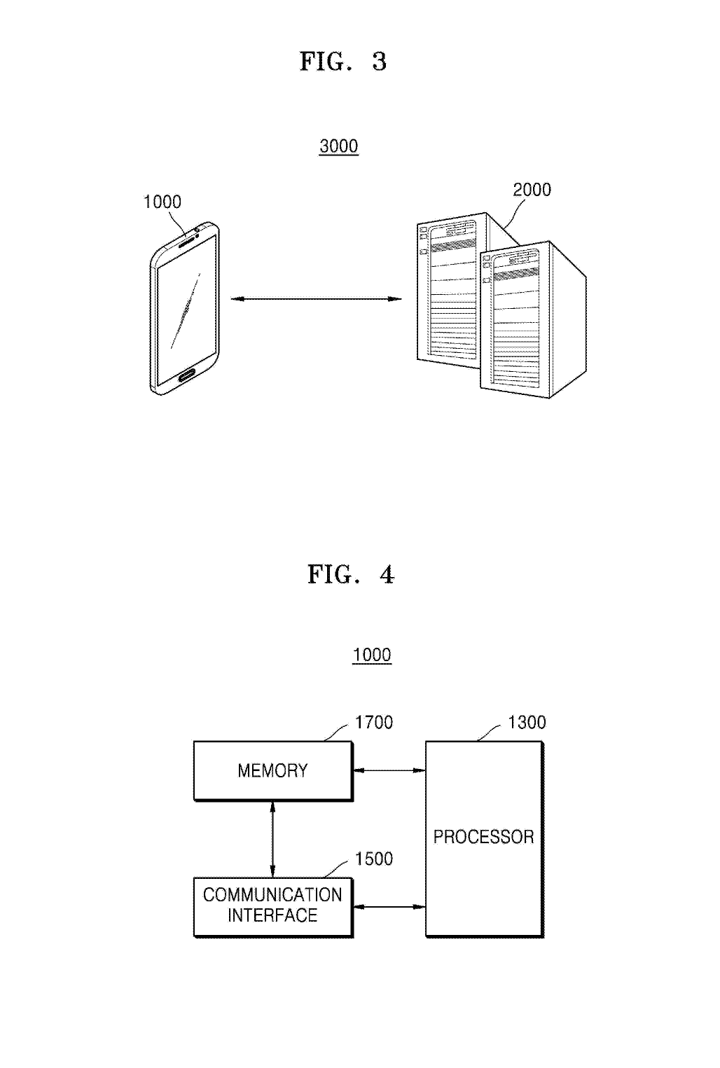

According to an embodiment of the disclosure, data transmitted from a first electronic device 1000 (in FIG. 3) to a second electronic device 2000 (in FIG. 3) may include a value output from at least one node in a last layer, which has been processed by the first electronic device 1000. Data transmitted from the first electronic device 1000 to the second electronic device 2000 may include edge data acquired by applying different weights to the value output from the at least one node in the last layer, which has been processed by the first electronic device 1000.

According to an embodiment of the disclosure, each node in the neural network model 100 may be processed by inputting data collected in various methods to the neural network model 100.

An input value which can be input to the neural network model 100 may include various types of information collected by a device used by a user, such as, for example, and without limitation, a value input by the user, information sensed by a certain sensor, or the like. Hereinafter, information which can be input to the neural network model 100, as information collected by the device used by the user, may be referred to as raw data.

According to an embodiment of the disclosure, the raw data may include information requiring high security, such as, for example, and without limitation, information related to personal matters of the user, information related to a password, information sensed by a sensor, financial information, biometric information, or the like.

According to an embodiment of the disclosure, an operation of processing the neural network model 100 may use a large amount of computation, and thus, the neural network model 100 may be loaded and processed in another high-performance device, e.g., a server device, instead of a device which has collected raw data. For example, the collection of the raw data may be performed by the first electronic device 1000, and the operation of processing the neural network model 100 may be performed by the second electronic device 2000.

However, when the operation of processing the neural network model 100 is performed by a device other than the device which has collected the raw data, the raw data may be leaked in a transmission process based on transmission of the raw data from the device which has collected the raw data to the other device.

According to an embodiment of the disclosure, without transmitting the raw data to the other device as it is, values processed through partial nodes of the neural network model 100, which process the raw data as an input value, may be transmitted to the other device. The values processed through partial nodes of the neural network model 100 may be, for example, values of 0 or 1 or values in a different format from the raw data. Therefore, according to an embodiment of the disclosure, values in a different format from the raw data or values from which the raw data is hardly inferred may be transmitted to the other device, and thus, the possibility that the raw data is leaked in a transmission process may be reduced.

According to an embodiment of the disclosure, the nodes 112, 113, 114, and 115 included in a first group 110 among nodes in the neural network model 100 may be processed by the first electronic device 1000. The first group 110 in the neural network model 100, which is to be processed by the first electronic device 1000, may be determined based, for example, and without limitation, on at least one of a data transmission rate between the first electronic device 1000 and the second electronic device 2000, a size of a value to be transmitted from the first electronic device 1000 to the second electronic device 2000, computation capabilities of the first electronic device 1000 and the second electronic device 2000, or the like. For example, besides the examples described above, the first group 110 in the neural network model 100, which is to be processed by the first electronic device 1000, may be determined in various methods.

For example, when the first group 110 in the neural network model 100, which is to be processed by the first electronic device 1000, is determined in a layer unit, the first group 110 in the neural network model 100, which is to be processed by the first electronic device 1000, may be determined based on a layer having a least number of nodes among layers in the neural network model 100. As the number of nodes in a last layer, which are processed by the first electronic device 1000, is small, a size of a value to be transmitted from the first electronic device 1000 to the second electronic device 2000 may be small. According to an embodiment of the disclosure, the first group 110 in the neural network model 100, which is to be processed by the first electronic device 1000, may be determined such that a size of a value to be transmitted from the first electronic device 1000 to the second electronic device 2000 is small as a data transmission rate between the first electronic device 1000 and the second electronic device 2000 is low.

In addition, when a value to be transmitted from the first electronic device 1000 to the second electronic device 2000 is edge data obtained by applying different weights in respective nodes, the first group 110 in the neural network model 100, which is to be processed by the first electronic device 1000, may be determined based on the number or size of pieces of edge data output from each layer. For example, the first group 110 in the neural network model 100, which is to be processed by the first electronic device 1000, may be determined such that a size of a value to be transmitted from the first electronic device 1000 to the second electronic device 2000 is small as the number or size of pieces of edge data output from each layer is small.

In addition, the first group 110 and a second group 120 in the neural network model 100, which are to be processed by the first electronic device 1000 and the second electronic device 2000, may be determined based on computation capabilities of the first electronic device 1000 and the second electronic device 2000, respectively. For example, when the computation capability of the second electronic device 2000 is better than that of the first electronic device 1000, the first group 110 and the second group 120 in the neural network model 100, which are to be processed by the first electronic device 1000 and the second electronic device 2000, may be determined respectively, such that the number of nodes to be processed by the second electronic device 2000 is greater than the number of nodes to be processed by the first electronic device 1000.

According to an embodiment of the disclosure, the second electronic device 2000 may process at least one node in the second group 120 among nodes in the neural network model 100, which has not been processed by the first electronic device 1000, based on a value received from the first electronic device 1000. For example, the second electronic device 2000 may process the second group 120 in the neural network model 100 by inputting a value received from the first electronic device 1000 to nodes in the at least one hidden layer 121 included in the second group 120.

When the output layer 122 is included in the second group 120, the second electronic device 2000 may acquire an output value output from the output layer 122 as an output value of the neural network model 100. In addition, the second electronic device 2000 may transmit the output value of the neural network model 100 to the first electronic device 1000. The first electronic device 1000 may perform a certain operation using the received output value of the neural network model 100.

According to the example described above, the neural network model 100 may be processed by being divided into the first group 110 and the second group 120, but the present embodiment of the disclosure is not limited thereto, and the neural network model 100 may be divided into three or more groups. For example, the neural network model 100 may be divided into n groups, wherein each group may be processed by a corresponding electronic device.

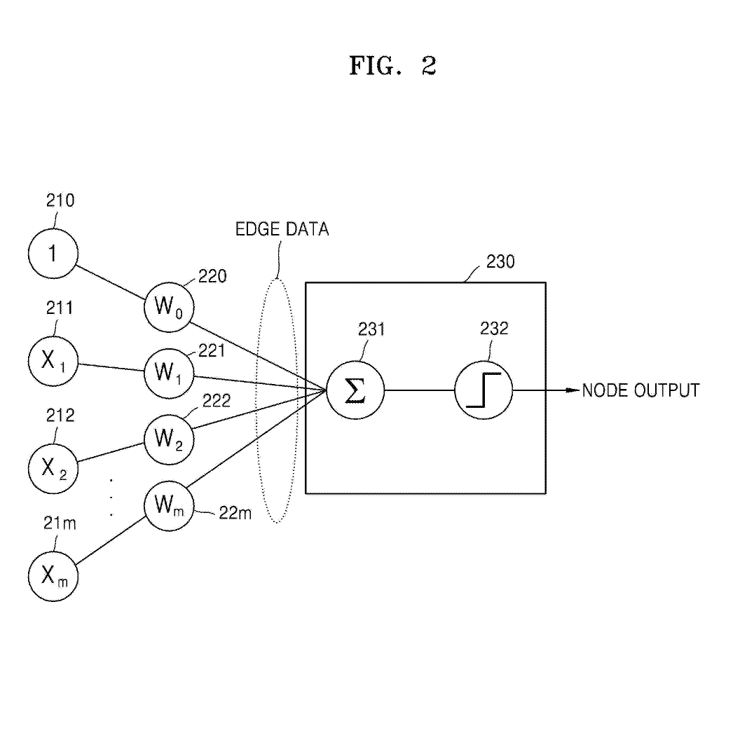

FIG. 2 is a diagram illustrating an example node included in the neural network model 100, according to an embodiment of the disclosure.

Referring to FIG. 2, at least one input value 210, 211, 212, . . . , 21m may be input to one node 230. According to an embodiment of the disclosure, the at least one input value 210, 211, 212, . . . , 21m is raw data, or data output as a result obtained by processing another node. In addition, respective weights 220, 221, 222, . . . , 22m may be applied to the at least one input value 210, 211, 212, . . . , 21m, and then the weight-applied at least one input value 210, 211, 212, . . . , 21m may be input to the node 230. The weight-applied at least one input value 210, 211, 212, . . . , 21m may correspond, for example, to the edge data described above.

Values input to the node 230 may, for example, be added by an add function 231, and then an output value of the node 230 may be acquired by an activation function 232.

The activation function 232 may be one of, for example, and without limitation, an identity function, a ramp function, a step function, a sigmoid function, or the like, but is not limited thereto, and various types of activation functions may be used. A value obtained by adding the at least one input value 210, 211, 212, . . . , 21m by the add function may be input as an input value of the activation function 232. An output value of the activation function 232 may be output as an output value of the node 230, and a weight corresponding to the node 230 may be applied to the output value of the node 230, and the weight-applied output value of the node 230 may be input to another node.

FIG. 3 is a diagram illustrating an example system 3000 for processing a neural network model using a plurality of electronic devices, according to an embodiment of the disclosure.

Referring to FIG. 3, the system 3000 for processing a neural network model using a plurality of electronic devices may include the first electronic device 1000 and the second electronic device 2000 as the plurality of electronic devices. According to an embodiment of the disclosure, the first electronic device 1000 and the second electronic device 2000 may, for example, and without limitation, be a terminal and a server, respectively. However, the present embodiment of the disclosure is not limited thereto, and the first electronic device 1000 and the second electronic device 2000 may be ones of various types of electronic devices such as, for example, and without limitation, a gateway, or the like. In addition, the system 3000 illustrated in FIG. 3 includes only two electronic devices, but the present embodiment of the disclosure is not limited thereto, and the system 3000 according to an embodiment of the disclosure may include three or more electronic devices and process a neural network model.

According to an embodiment of the disclosure, a plurality of nodes to be respectively processed by the plurality of electronic devices among the nodes included in the neural network model 100 may be determined, and the plurality of electronic devices may acquire an output value of the neural network model 100 by processing the plurality of nodes in the neural network model 100.

For example, the first electronic device 1000 may process at least one node included in a first group in the neural network model 100. The first group may include an input layer configured to receive an input value. The second electronic device 2000 may process at least one node included in a second group in the neural network model 100 except for the nodes processed by the first electronic device 1000. The second group may include an output layer configured to output an output value. The second electronic device 2000 may output the output value of the output layer as an output value of the neural network model 100. The second electronic device 2000 may transmit the output value of the neural network model 100 to the first electronic device 1000.

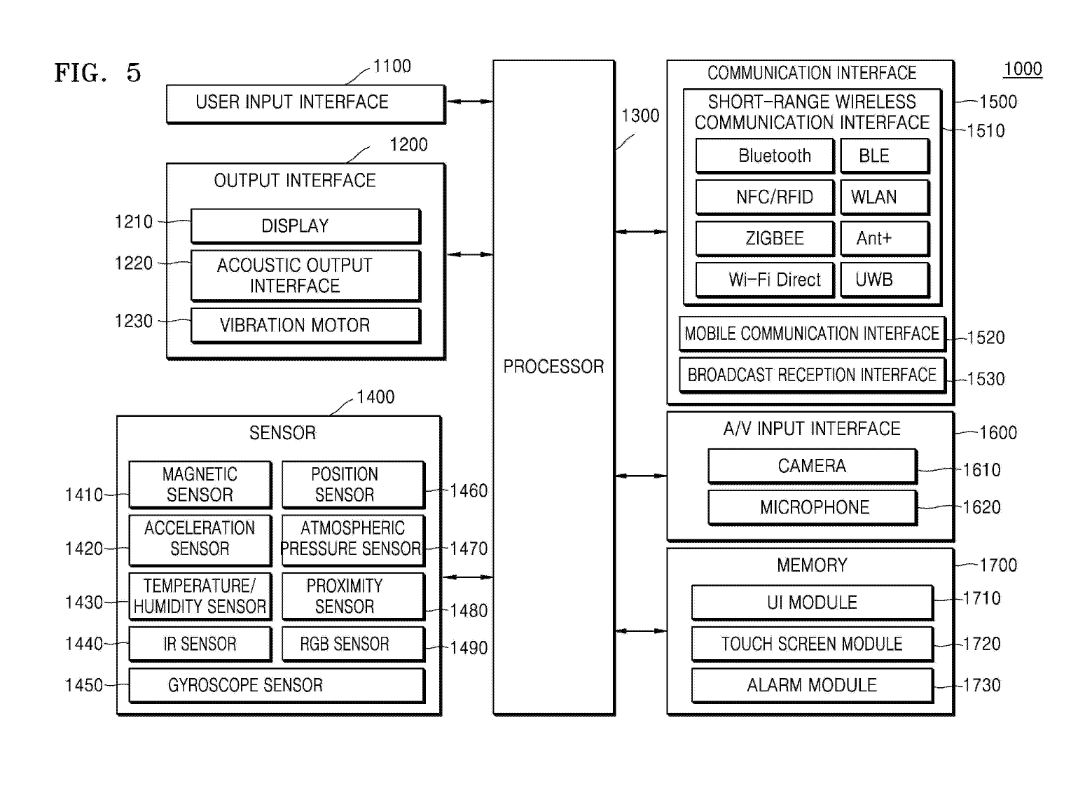

FIG. 4 is a block diagram illustrating an example of the first electronic device 1000 according to various embodiments of the disclosure.

FIG. 5 is a block diagram illustrating an example of the first electronic device 1000 according to various embodiments of the disclosure.

As illustrated in FIG. 4, the first electronic device 1000 according to various embodiments of the disclosure may include a memory 1700, a communication interface (e.g., including communication circuitry) 1500, and a processor (e.g., including processing circuitry) 1300. However, not all of the components shown in FIG. 4 are mandatory components of the first electronic device 1000. The first electronic device 1000 may be implemented by more or less components than the components shown in FIG. 4.

For example, as shown in FIG. 5, the first electronic device 1000 according to various embodiments of the disclosure may further include a user input interface (e.g., including input circuitry) 1100, an output interface (e.g., including output circuitry) 1200, a sensor 1400, and an audio/video (A/V) input interface (e.g., including A/V input circuitry) 1600 besides the memory 1700, the communication interface 1500, and the processor 1300.

The user input interface 1100 may refer, for example, to a means through which the user inputs data for controlling the first electronic device 1000. For example, the user input interface 1100 may include various input circuitry, such as, for example, and without limitation, a keypad, a dome switch, a touch pad (a capacitive overlay touch pad, a resistive overlay touch pad, an infrared (IR) beam touch pad, a surface acoustic wave touch pad, an integral strain gauge touch pad, a piezoelectric touch pad, or the like), a jog wheel, a jog switch, and the like, but is not limited thereto.

The user input interface 1100 may receive the user's input of certain data which may be included in raw data.

The output interface 1200 may output an audio signal, a video signal, or a vibration signal and may include various output circuitry, such as, for example, and without limitation, a display 1210, an acoustic output interface 1220, and a vibration motor 1230, or the like.

The display 1210 may display information processed by the first electronic device 1000. For example, the display 1210 may display a value input from the user through the user input interface 1100. In addition, the display 1210 may display a result processed by the neural network model 100.

When the display 1210 and a touch pad form a layer structure to configure a touch screen, the display 1210 may be used as not only an output device but also an input device. The display 1210 may include, for example, and without limitation, at least one of a liquid crystal display, a thin-film transistor liquid crystal display, an organic light-emitting diode, a flexible display, a three-dimensional (3D) display, an electrophoretic display, or the like. In addition, the first electronic device 1000 may include two or more displays 1210 according to implementation forms of the first electronic device 1000.

The acoustic output interface 1220 may include various circuitry and output audio data received through the communication interface 1500 or stored in the memory 1700.

The vibration motor 1230 may output a vibration signal. In addition, the vibration motor 1230 may output a vibration signal when a touch is input through a touch screen.

The processor 1300 may include various processing circuitry and commonly control a general operation of the first electronic device 1000. For example, the processor 1300 may generally control the user input interface 1100, the output interface 1200, the sensor 1400, the communication interface 1500, the A/V input interface 1600, and the like by executing programs stored in the memory 1700.

For example, the processor 1300 may acquire an input value of the neural network model 100 and process at least one node included in a first group in the neural network model 100. Upon processing the at least one node included in the first group in the neural network model 100, the processor 1300 may transmit at least one value output from the first group to the second electronic device 2000. The second electronic device 2000 may process at least one node included in a second group in the neural network model 100, based on the at least one value output from the first group. The second electronic device 2000 may transmit a value output from the second group to the first electronic device 1000.

The sensor 1400 may detect a state of the first electronic device 1000 and/or an ambient state of the first electronic device 1000 and transmit the detected information to the processor 1300. According to an embodiment of the disclosure, the information detected by the sensor 1400 may be used as an input value of the neural network model 100.

The sensor 1400 may include, for example, and without limitation, at least one of a magnetic sensor 1410, an acceleration sensor 1420, a temperature/humidity sensor 1430, an IR sensor 1440, a gyroscope sensor 1450, a position sensor (e.g., global positioning system (GPS)) 1460, an atmospheric pressure sensor 1470, a proximity sensor 1480, an RGB (illuminance) sensor 1490, or the like, but is not limited thereto.

The communication interface 1500 may include at least one component for communicating between the first electronic device 1000 and the second electronic device 2000 or an external device (not shown). For example, the communication interface 1500 may include various communication circuitry included in various example interfaces, such as, for example, and without limitation, a short-range wireless communication interface 1510, a mobile communication interface 1520, and a broadcast reception interface 1530.

The short-range wireless communication interface 1510 may include, for example, and without limitation, a Bluetooth communication interface, a Bluetooth low energy (BLE) communication interface, a near-field communication interface (NFC/RFID), a wireless local area network (WLAN) (Wi-Fi) communication interface, a Zigbee communication interface, an infrared data association (IrDA) communication interface, a Wi-Fi Direct (WFD) communication interface, an ultra-wideband (UWB) communication interface, an Ant+ communication interface, and the like but is not limited thereto.

The mobile communication interface 1520 may, for example, transmit and receive a wireless signal to and from at least one of a base station, an external terminal, or a server in a mobile communication network. Herein the wireless signal may include a voice call signal, a video call signal, or various types of data according to text/multimedia message transmission and reception.

The broadcast reception interface 1530 may receive a broadcast signal and/or broadcast related information from the outside through a broadcast channel, and the broadcast channel may include a satellite channel and a terrestrial channel. According to implementation examples, the first electronic device 1000 may not include the broadcast reception interface 1530.

According to an embodiment of the disclosure, the communication interface 1500 may transmit and receive information required for processing the neural network model 100 to and from the second electronic device 2000 and an external server (not shown). For example, the communication interface 1500 may transmit at least one value output from the first group in the neural network model 100 to the second electronic device 2000 by which at least one node included in the second group in the neural network model 100 is to be processed. In addition, the communication interface 1500 may receive, from the second electronic device 2000, a value output from the second group as an output value of the neural network model 100.

The A/V input interface 1600 may include various A/V input circuitry configured to input an audio signal or a video signal and may include, for example, and without limitation, a camera 1610, a microphone 1620, and the like. The camera 1610 may obtain an image frame of a still image, a moving picture, or the like through an image sensor in a video call mode or a capturing mode. An image captured through the image sensor may be processed by the processor 1300 or a separate image processor (not shown). According to an embodiment of the disclosure, the audio signal or the video signal received by the A/V input interface 1600 may be the raw data described above and may be used as an input value of the neural network model 100.

The microphone 1620 may receive an external acoustic signal and process the external acoustic signal to electrical voice data. For example, the microphone 1620 may receive an acoustic signal from an external device or the user. According to an embodiment of the disclosure, the acoustic signal received by the microphone 1620 may be the raw data described above and may be used as an input value of the neural network model 100.

The memory 1700 may store programs for processing and control of the processor 1300 and store data input to the first electronic device 1000 or output from the first electronic device 1000. The memory 1700 may store the neural network model 100. In addition, the memory 1700 may store various types of user data for training and updating the neural network model 100. According to an embodiment of the disclosure, the various types of data stored in the memory 1700 are the raw data described above and may be used as an input value of the neural network model 100.

The memory 1700 may include, for example, and without limitation, at least one type of storage medium among a flash memory type memory, a hard disk type memory, a multimedia card micro type memory, a card type memory (e.g., a secure digital (SD) or extreme digital (XD) memory), random access memory (RAM), static RAM (SRAM), read only memory (ROM), electrically erasable programmable ROM (EEPROM), PROM, a magnetic memory, a magnetic disc, an optical disc, or the like.

The programs stored in the memory 1700 may be classified into a plurality of modules according to functions thereof, such as, for example, and without limitation, a user interface (UI) module 1710, a touch screen module 1720, an alarm module 1730, and the like.

The UI module 1710 may include various program elements and provide a specified UI, a specified graphic UI (GUI), or the like interoperating with the first electronic device 1000 for each application. The touch screen module 1720 may include various program elements and sense a touch gesture of the user on a touch screen and transmit information regarding the touch gesture to the processor 1300. According to various embodiments of the disclosure, the touch screen module 1720 may recognize and analyze a touch code. The touch screen module 1720 may be configured by separate hardware including a controller.

Various sensors may be provided inside or around the touch screen to sense a touch or a proximity touch on the touch screen. One example of the sensors configured to sense a touch on the touch screen is a tactile sensor. The tactile sensor indicates a sensor configured to sense a touch of a certain object in a level which a human being feels or more. The tactile sensor may sense various pieces of information such as roughness of a contact surface, hardness of a contact object, and a temperature of a contact point.

The touch gesture of the user may include, for example, and without limitation, tap, touch & hold, double tap, drag, panning, flick, drag & drop, swipe, and the like.

The alarm module 1730 may include various program elements and generate a signal for informing of the occurrence of an event of the first electronic device 1000.

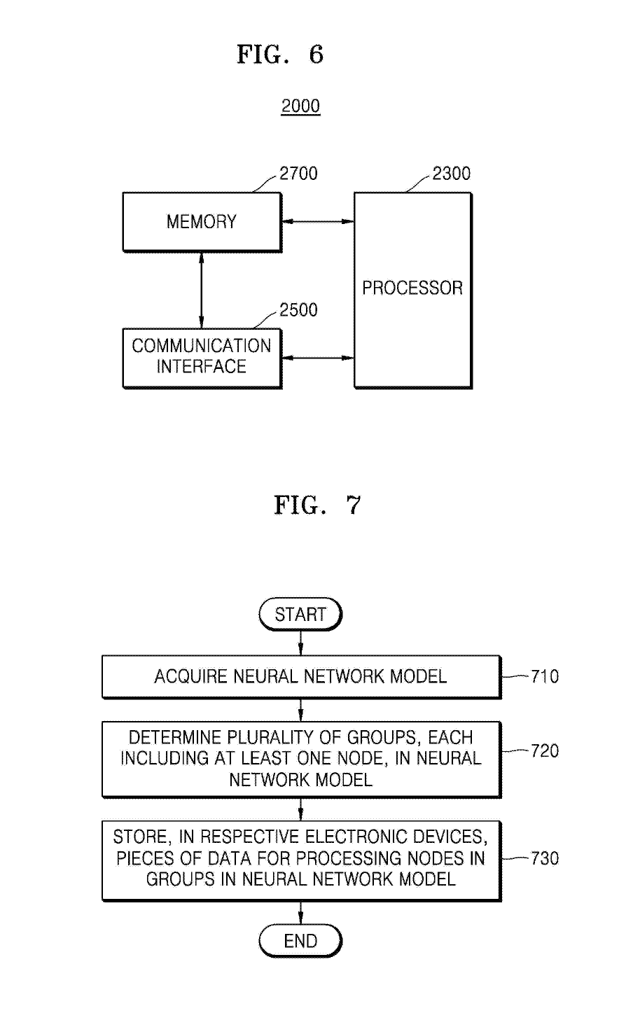

FIG. 6 is a block diagram illustrating an example of the second electronic device 2000 according to an embodiment of the disclosure.

As shown in FIG. 6, the second electronic device 2000 according to various embodiments of the disclosure may include a memory 2700, a communication interface (e.g., including communication circuitry) 2500, and a processor (e.g., including processing circuitry) 2300. The memory 2700, the communication interface 2500, and the processor 2300 of the second electronic device 2000 may correspond to the memory 1700, the communication interface 1500, and the processor 1300 of the first electronic device 1000, respectively, and the description as made with reference FIG. 4 is the same or similar and will not be repeated here.

However, not all of the components shown in FIG. 6 are mandatory components of the second electronic device 2000. The second electronic device 2000 may be implemented by more or less components than the components shown in FIG. 6.

For example, the second electronic device 2000 according to various embodiments of the disclosure may further include a user input interface (not shown), an output interface (not shown), a sensor (not shown), and an A/V input interface (not shown) besides the memory 2700, the communication interface 2500, and the processor 2300. The user input interface (not shown), the output interface (not shown), the sensor (not shown), and the A/V input interface (not shown) of the second electronic device 2000 may correspond to the user input interface 1100, the output interface 1200, the sensor 1400, and the A/V input interface 1600 of the first electronic device 1000, respectively, and the same description as made with reference FIG. 5 is omitted herein.

The memory 2700 may store programs for processing and control of the processor 2300 and store data received from the first electronic device 1000. The memory 2700 may store the neural network model 100. In addition, the memory 2700 may store various types of user data for training and updating the neural network model 100.

According to an embodiment of the disclosure, the memory 2700 may store data required to process at least one node included in a second group in the neural network model 100, which is to be processed by the second electronic device 2000. In addition, according to an embodiment of the disclosure, the memory 2700 may store at least one value output from a first group in the neural network model 100, which is received from the first electronic device 1000. In addition, according to an embodiment of the disclosure, the memory 2700 may store at least one value output from the second group.

The communication interface 2500 may include various communication circuitry including at least one component for allowing the second electronic device 2000 to communicate with the first electronic device 1000 or an external device (not shown). According to an embodiment of the disclosure, the communication interface 2500 may receive, from the first electronic device 1000, at least one value output from the first group in the neural network model 100. In addition, the communication interface 2500 may transmit, to the first electronic device 1000, at least one value output from the second group as an output value of the neural network model 100.

The processor 2300 may include various processing circuitry and commonly control a general operation of the second electronic device 2000. For example, the processor 2300 may generally control the communication interface 2500 and the like by executing programs stored in the memory 2700.

For example, the processor 2300 may acquire at least one node included in the second group in the neural network model 100. In addition, the processor 2300 may process the at least one node included in the second group based on at least one value received from the first electronic device 1000. In addition, upon processing the at least one node included in the second group in the neural network model 100, the processor 2300 may transmit an output value output from an output layer to the first electronic device 1000 as an output value of the neural network model 100.

FIG. 7 is a flowchart illustrating an example method of storing the neural network model 100 in a plurality of electronic devices, according to an embodiment of the disclosure.

According to an embodiment of the disclosure, the neural network model 100 may be trained based on various types of data collected in various methods. Upon training the neural network model 100, various types of values in the neural network model 100, such as, for example, and without limitation, a connection relationship between nodes, the activation function 232 in a node, and the weights 220, 221, 222, . . . , 22m, may be modified. When the training of the neural network model 100 is completed, the neural network model 100 may be stored such that the neural network model 100 is processed by a plurality of electronic devices, according to an embodiment of the disclosure.

According to an embodiment of the disclosure, the neural network model 100 may be acquired by one of the plurality of electronic devices by which the neural network model 100 is processed, but the various example embodiments of the disclosure are not limited thereto, and the neural network model 100 may be acquired by an external device other than the first and second electronic devices 1000 and 2000 by which the neural network model 100 is processed. Hereinafter, for convenience of description, it is assumed that the neural network model 100 is acquired by the second electronic device 2000 and is stored in the plurality of electronic devices.

Referring to FIG. 7, in operation 710, the second electronic device 2000 may acquire the neural network model 100 to be processed by the plurality of electronic devices (the first and second electronic devices 1000 and 2000). For example, the second electronic device 2000 may acquire the neural network model 100 of which training has been completed, based on various types of data. According to an embodiment of the disclosure, every time that training of the neural network model 100 is completed, operations 710 to 730 in FIG. 7 may be repeated. However, the disclosure is not limited thereto.

In operation 720, the second electronic device 2000 may determine a plurality of groups, each including at least one node in the neural network model 100. Each of the groups determined in operation 720 may include at least one node which may be processed by each of the plurality of electronic devices (the first and second electronic devices 1000 and 2000). According to an embodiment of the disclosure, one group in the neural network model 100 may include at least one node in a layer unit. For example, a first group in the neural network model 100, which is to be processed by the first electronic device 1000, may include nodes of an input layer. In addition, a second group in the neural network model 100, which is to be processed by the second electronic device 2000, may include nodes of the at least one hidden layer and an output layer.

According to an embodiment of the disclosure, the second electronic device 2000 may determine a plurality of groups in the neural network model 100 based, for example, and without limitation, on at least one of a data transmission rate between the first electronic device 1000 and the second electronic device 2000, a size of a value to be transmitted from the first electronic device 1000 to the second electronic device 2000, computation capabilities of the first electronic device 1000 and the second electronic device 2000, or the like, but is not limited thereto. For example, besides the examples described above, the second electronic device 2000 may determine the plurality of groups in the neural network model 100 using various methods.

In operation 730, the second electronic device 2000 may store pieces of data for processing nodes in groups of the neural network model 100, the groups having been determined in operation 720, in respective electronic devices. For example, the second electronic device 2000 may transmit, to the first electronic device 1000, data for processing nodes in a group to be processed by the first electronic device 1000. The first electronic device 1000 may store, in the memory 1700, the data received from the second electronic device 2000. In addition, the second electronic device 2000 may store, in the memory 2700 of the second electronic device 2000, data for processing nodes in a group to be processed by the second electronic device 2000. The first electronic device 1000 and the second electronic device 2000 may process the first group and the second group in the neural network model 100 by using the data stored in the memories 1700 and 2700 of the first electronic device 1000 and the second electronic device 2000, respectively.

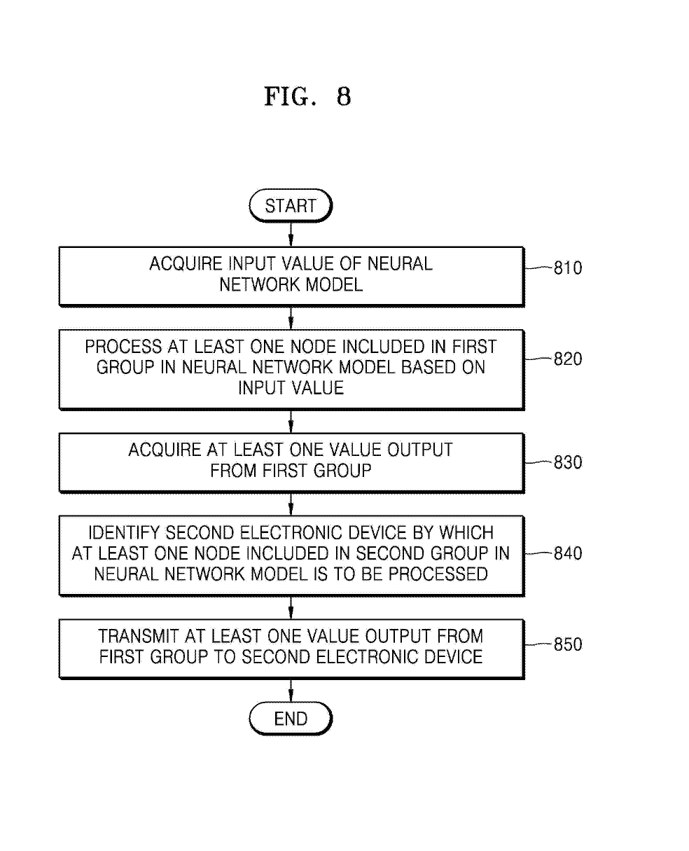

FIG. 8 is a flowchart illustrating an example method, performed by a plurality of electronic devices, of processing a neural network model, according to an embodiment of the disclosure.

According to an embodiment of the disclosure, the first electronic device 1000 may process the neural network model 100 according to an embodiment of the disclosure to perform a certain application or program operation. The first electronic device 1000 may perform the certain application or program operation using an output value acquired as a result of processing the neural network model 100.

For example, the first electronic device 1000 may process the neural network model 100 to perform voice recognition on an input voice signal. The first electronic device 1000 may perform a voice recognition operation on the input voice signal.

Referring to FIG. 8, in operation 810, the first electronic device 1000 may acquire an input value for processing the neural network model 100. For example, a voice signal on which voice recognition is to be performed may be acquired as the input value.

In operation 820, the first electronic device 1000 may process at least one node included in a first group in the neural network model 100 based on the input value acquired in operation 810. According to an embodiment of the disclosure, the first electronic device 1000 may process the at least one node included in the first group in the neural network model 100 by inputting the acquired input value to an input layer in the neural network model 100.

According to an embodiment of the disclosure, instead that the input value is transmitted to the second electronic device 2000 and processed, the input value may be input to the first group in the neural network model 100 in the first electronic device 1000. Therefore, the first electronic device 1000 may transmit a value output from the first group in the neural network model 100 to the second electronic device 2000 instead of the input value.

In operation 830, the first electronic device 1000 may acquire at least one value output from the first group, by processing the at least one node in the first group. For example, the first electronic device 1000 may acquire at least one piece of edge data output by processing the at least one node.

In operation 840, the first electronic device 1000 may identify the second electronic device 2000 by which at least one node included in a second group in the neural network model 100 is to be processed. According to an embodiment of the disclosure, the first electronic device 1000 may identify the second electronic device 2000 in operation 840 based on previously determined information on a device by which the at least one node included in the second group in the neural network model 100 is to be processed. According to an embodiment of the disclosure, the device by which the at least one node included in the second group is to be processed may be determined every time that the neural network model 100 is trained.

In operation 850, the first electronic device 1000 may transmit the at least one value output from the first group to the second electronic device 2000 identified in operation 840. For example, the first electronic device 1000 may transmit, to the second electronic device 2000, the at least one piece of edge data output by processing the at least one node in the first group.

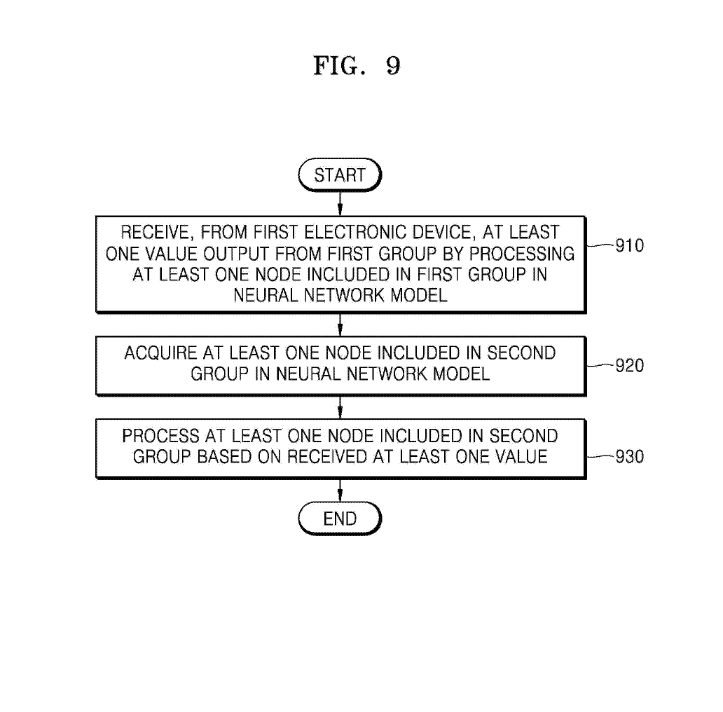

FIG. 9 is a flowchart illustrating an example method, performed by a plurality of electronic devices, of processing a neural network model, according to an embodiment of the disclosure.

Referring to FIG. 9, in operation 910, the second electronic device 2000 may receive, from the first electronic device 1000, at least one value output from a first group by processing at least one node in the neural network model 100. The at least one value received from the first electronic device 1000 may be a value output from the first group by processing at least one node included in the first group in the neural network model 100. For example, the second electronic device 2000 may receive, from the first electronic device 1000, edge data output by processing the at least one node included in the first group.

In operation 920, the second electronic device 2000 may acquire at least one node included in a second group in the neural network model 100.

In operation 930, the second electronic device 2000 may process the at least one node included in the second group in the neural network model 100 based on the at least one value received from the first electronic device 1000 in operation 910.

According to an embodiment of the disclosure, the second electronic device 2000 may acquire an output value of the neural network model 100, which is output from an output layer, by processing the at least one node included in the second group in the neural network model 100. The second electronic device 2000 may transmit the output value of the neural network model 100 to the first electronic device 1000 such that the first electronic device 1000 outputs a processing result of the neural network model 100. For example, the first electronic device 1000 may output a voice recognition result for the input voice signal based on the output value of the neural network model 100, which has been received from the second electronic device 2000.

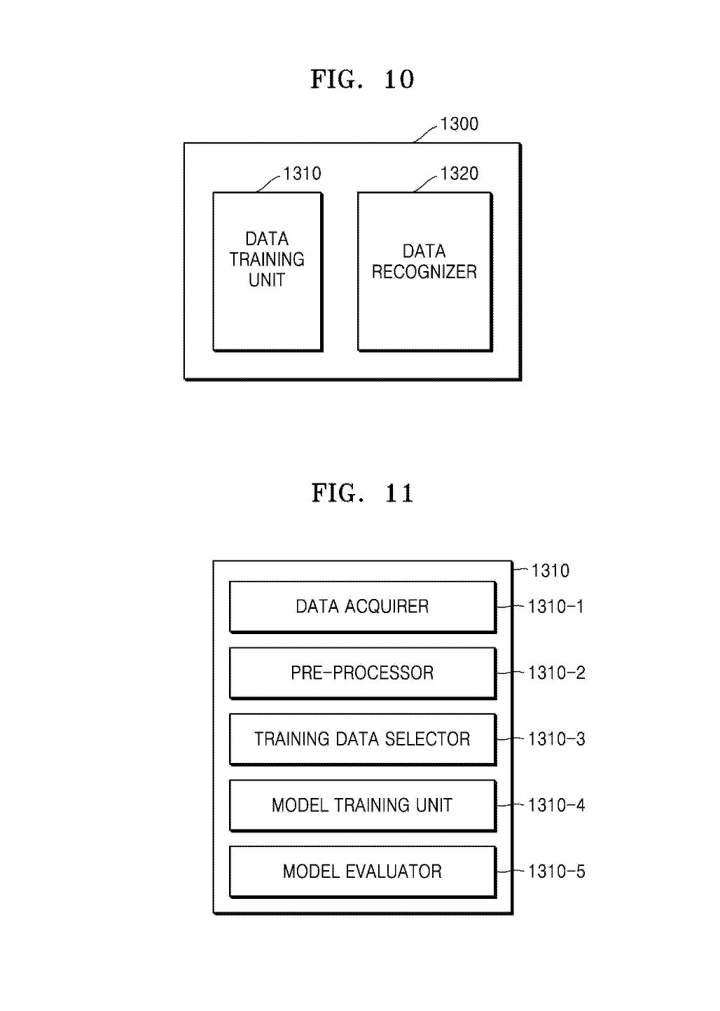

FIG. 10 is a block diagram illustrating an example of the processor 1300 included in the first electronic device 1000, according to an embodiment of the disclosure.

Referring to FIG. 10, the processor 1300 according to an embodiment of the disclosure may include a data training unit (e.g., including processing circuitry and/or program elements) 1310 and a data recognizer (e.g., including processing circuitry and/or program elements) 1320.

The data training unit 1310 may include various processing circuitry and/or program elements and train a reference for context determination. The data training unit 1310 may train a reference of which data is used to determine a certain context and a reference of how to determine the context using the data. The data training unit 1310 may train a reference for the context determination by acquiring data to be used for the training and applying the acquired data to a neural network model to be described below.

The data recognizer 1320 may include various processing circuitry and/or program elements and determine a context based on data. The data recognizer 1320 may recognize a context from certain data using the trained neural network model. The data recognizer 1320 may determine a certain context based on certain data by acquiring the certain data according to a preset reference through training and using a neural network model to which the acquired data is input as an input value. In addition, a result value output from the neural network model to which the acquired data is input as the input value may be used to update the neural network model.

At least one of the data training unit 1310 and the data recognizer 1320 may be manufactured in a form of at least one hardware chip and equipped in an electronic device. For example, at least one of the data training unit 1310 and the data recognizer 1320 may be manufactured in a form of, for example, and without limitation, an exclusive hardware chip for an artificial intelligence (AI), manufactured as a part of an existing general-use processor (e.g., a central processing unit (CPU) or an application processor), a graphic exclusive processor (e.g., a graphic processing unit (GPU)), or the like, and may be equipped in various types of electronic devices described above.

The data training unit 1310 and the data recognizer 1320 may be equipped in one electronic device or respectively equipped in individual electronic devices. For example, one of the data training unit 1310 and the data recognizer 1320 may be included in an electronic device, and the other one may be included in a server. In addition, in a wired or wireless manner between the data training unit 1310 and the data recognizer 1320, model information constructed by the data training unit 1310 may be provided to the data recognizer 1320, and data input to the data recognizer 1320 may be provided as additional training data to the data training unit 1310.

At least one of the data training unit 1310 and the data recognizer 1320 may be implemented as a software module. When at least one of the data training unit 1310 and the data recognizer 1320 is implemented as a software module (or a program module including instructions), the software module may be stored in a non-transitory computer-readable recording medium. In addition, in this case, at least one software module may be provided by an operating system (OS) or a certain application. A part of the at least one software module may be provided by the OS, and the other part may be provided by the certain application.

FIG. 11 is a block diagram illustrating an example of the data training unit 1310 according to an embodiment of the disclosure.

Referring to FIG. 11, the data training unit 1310 according to an embodiment of the disclosure may include a data acquirer (e.g., including processing circuitry and/or program elements) 1310-1, a pre-processor (e.g., including processing circuitry and/or program elements) 1310-2, a training data selector (e.g., including processing circuitry and/or program elements) 1310-3, a model training unit (e.g., including processing circuitry and/or program elements) 1310-4, and a model evaluator (e.g., including processing circuitry and/or program elements) 1310-5.

The data acquirer 1310-1 may include various processing circuitry and/or program elements and acquire data required to determine a context. The data acquirer 1310-1 may data required for training for the context determination.

The data acquirer 1310-1 may acquire voice data, image data, text data, vital sign data, or the like. For example, the data acquirer 1310-1 may receive data through an input apparatus (e.g., a microphone, a camera, a sensor, or the like) of an electronic device. The data acquirer 1310-1 may acquire data through an external device which communicates with the electronic device.

In addition, the data acquirer 1310-1 may acquire various types of raw data. The raw data may include, for example, a text input from the user, personal information of the user, which is stored in the first electronic device 1000, sensor information sensed by the first electronic device 1000, biometric information, and the like but is not limited thereto.

The pre-processor 1310-2 may include various processing circuitry and/or program elements and pre-process the acquired data such that the acquired data is used for training to determine a context. The pre-processor 1310-2 may process the acquired data in a preset format such that the model training unit 1310-4 to be described below uses the acquired data for training to determine a context.

The training data selector 1310-3 may include various processing circuitry and/or program elements and select data required for training from among the pre-processed data. The selected data may be provided to the model training unit 1310-4. The training data selector 1310-3 may select data required for training from among the pre-processed data according to a preset reference for context determination. The training data selector 1310-3 may select data according to a reference preset by training in the model training unit 1310-4 to be described below.

The model training unit 1310-4 may include various processing circuitry and/or program elements and train, based on training data, a reference of how to determine a context. In addition, the model training unit 1310-4 may train a reference of which training data is to be used to determine a context.

In addition, the model training unit 1310-4 may train a neural network model, which is to be used to determine a context, by using training data. In this case, the neural network model may be a pre-constructed model. For example, the neural network model may be a model pre-constructed by receiving basic training data (e.g., a sample image or the like). In addition, the neural network model may be constructed by considering an application field of the neural network model, a purpose of training, a computing performance of a device, or the like.

According to some embodiments of the disclosure, when there exist a plurality of pre-constructed neural network models, the model training unit 1310-4 may determine, as a neural network model to be trained, a neural network model having a high relation of basic training data with input training data. In this case, the basic training data may be pre-classified for each data type, and the neural network models may be pre-classified for each data type. For example, the basic training data may be pre-classified based on various references such as a generation region of training data, a generation time of the training data, a size of the training data, a genre of the training data, a generator of the training data, and a type of an object in the training data.

The model training unit 1310-4 may train the neural network model using, for example, a training algorithm including error back-propagation or gradient descent.

The model training unit 1310-4 may train the neural network model through, for example, supervised training of which an input value is training data. The model training unit 1310-4 may train the neural network model through, for example, unsupervised training by which a reference for determining a context is discovered by training, by the model training unit 1310-4, a type of data required to determine a context without a separate supervision. The model training unit 1310-4 may train the neural network model through, for example, reinforcement training using a feedback on whether a result of determining a context according to training is right.

In addition, when the neural network model is trained, the model training unit 1310-4 may store the trained neural network model. According to an embodiment of the disclosure, the model training unit 1310-4 may divide the trained neural network model into a plurality of groups and store data for processing each group, in a memory of a device by which each group is to be processed. For example, data for processing a first group in the neural network model may be stored in the memory 1700 of the first electronic device 1000. In addition, data for processing a second group in the neural network model may be stored in the memory 2700 of the second electronic device 2000 connected to the first electronic device 1000 via a wired or wireless network.

A memory in which the trained neural network model is stored may also store, for example, a command or data related to at least one other component of the first electronic device 1000. In addition, the memory may store software and/or programs. The programs may include, for example, a kernel, middleware, an application programming interface (API) and/or application programs (or “applications”).

The model evaluator 1310-5 may include various processing circuitry and/or program elements and input evaluation data to the neural network model, and when a recognition result output from the neural network model does not satisfy a certain reference, the model evaluator 1310-5 may allow the model training unit 1310-4 to perform training again. In this case, the evaluation data may be preset data for evaluating the neural network model.

For example, when a number or percentage of pieces of evaluation data of which a recognition result is not correct among recognition results of the trained neural network model for the evaluation data exceeds a preset threshold, the model evaluator 1310-5 may evaluate that the certain reference is not satisfied. For example, when the certain reference is defined as 2%, when the trained neural network model outputs wrong recognition results for more than 20 pieces of evaluation data among a total of 1000 pieces of evaluation data, the model evaluator 1310-5 may evaluate that the trained neural network model is not suitable.

When there exist a plurality of trained neural network models, the model evaluator 1310-5 may evaluate whether each trained neural network model satisfies the certain reference and determine a model satisfying the certain reference as a final neural network model. In this case, when a plurality of models satisfy the certain reference, the model evaluator 1310-5 may determine, as the final neural network model, any one model or a certain number of models preset in an order of higher evaluation score.

At least one of the data acquirer 1310-1, the pre-processor 1310-2, the training data selector 1310-3, the model training unit 1310-4, or the model evaluator 1310-5 in the data training unit 1310 may be manufactured in a form of at least one hardware chip and equipped in an electronic device. For example, at least one of the data acquirer 1310-1, the pre-processor 1310-2, the training data selector 1310-3, the model training unit 1310-4, or the model evaluator 1310-5 may be manufactured in a form of, for example, and without limitation, an exclusive hardware chip for an AI, or manufactured as a part of an existing general-use processor (e.g., a CPU or an application processor), a graphic exclusive processor (e.g., a GPU), or the like, and may be equipped in various types of electronic devices described above.

In addition, the data acquirer 1310-1, the pre-processor 1310-2, the training data selector 1310-3, the model training unit 1310-4, and the model evaluator 1310-5 may be equipped in one electronic device or respectively equipped in individual electronic devices. For example, some of the data acquirer 1310-1, the pre-processor 1310-2, the training data selector 1310-3, the model training unit 1310-4, and the model evaluator 1310-5 may be included in an electronic device, and the other some may be included in a server.

At least one of the data acquirer 1310-1, the pre-processor 1310-2, the training data selector 1310-3, the model training unit 1310-4, or the model evaluator 1310-5 may be implemented as a software module. When at least one of the data acquirer 1310-1, the pre-processor 1310-2, the training data selector 1310-3, the model training unit 1310-4, or the model evaluator 1310-5 is implemented as a software module (or a program module including instructions), the software module may be stored in a non-transitory computer-readable recording medium. In addition, in this case, at least one software module may be provided by an OS or a certain application. A part of the at least one software module may be provided by the OS, and the other part may be provided by the certain application.

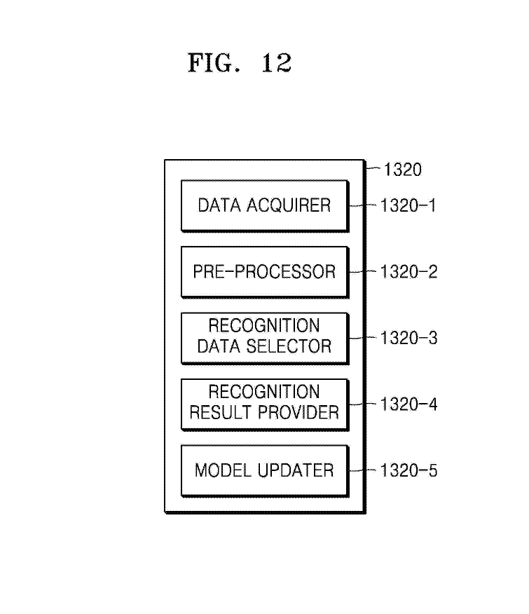

FIG. 12 is a block diagram illustrating an example of the data recognizer 1320 according to an embodiment of the disclosure.

Referring to FIG. 12, the data recognizer 1320 according to an embodiment of the disclosure may include a data acquirer (e.g., including processing circuitry and/or program elements) 1320-1, a pre-processor (e.g., including processing circuitry and/or program elements) 1320-2, a recognition data selector (e.g., including processing circuitry and/or program elements) 1320-3, a recognition result provider (e.g., including processing circuitry and/or program elements) 1320-4, and a model updater (e.g., including processing circuitry and/or program elements) 1320-5.

The data acquirer 1320-1 may include various processing circuitry and/or program elements and acquire data required to determine a context, and pre-processor 1320-2 may pre-process the acquired data such that the acquired data is used to determine a context. The pre-processor 1320-2 may process the acquired data in a preset format such that the recognition result provider 1320-4 to be described below uses the acquired data to determine a context.

The recognition data selector 1320-3 may include various processing circuitry and/or program elements and select, from among the pre-processed data, data required to determine a context. The selected data may be provided to the recognition result provider 1320-4. The recognition data selector 1320-3 may select a part or all of the pre-processed data according to a preset reference for determining a context. Alternatively, the recognition data selector 1320-3 may select data according to a reference preset by training in the model training unit 1310-4 described above.

The recognition result provider 1320-4 may include various processing circuitry and/or program elements and determine a context by applying the selected data to a neural network model. The recognition result provider 1320-4 may provide a recognition result according to a recognition purpose of the data. The recognition result provider 1320-4 may apply the selected data to the neural network model by using the data selected by the recognition data selector 1320-3 as an input value. In addition, the recognition result may be determined by the neural network model.

According to an embodiment of the disclosure, the recognition result provider 1320-4 of the first electronic device 1000 may process nodes included in a first group in the neural network model and transmit a processing result to the second electronic device 2000. In addition, the second electronic device 2000 may process nodes in a second group in the neural network model and transmit a processing result to the first electronic device 1000 as a recognition result.

The model updater 1320-5 may include various processing circuitry and/or program elements and update the neural network model based on an evaluation on the recognition result provided by the recognition result provider 1320-4. For example, the model updater 1320-5 may allow the model training unit 1310-4 to update the neural network model by providing the recognition result provided by the recognition result provider 1320-4 to the model training unit 1310-4.

According to an embodiment of the disclosure, every time that a neural network model is updated, groups in the neural network model, which may be processed by a plurality of electronic devices, may be determined.

At least one of the data acquirer 1320-1, the pre-processor 1320-2, the recognition data selector 1320-3, the recognition result provider 1320-4, or the model updater 1320-5 in the data recognizer 1320 may be manufactured in a form of at least one hardware chip and equipped in an electronic device. For example, at least one of the data acquirer 1320-1, the pre-processor 1320-2, the recognition data selector 1320-3, the recognition result provider 1320-4, or the model updater 1320-5 may be manufactured in a form of, for example, and without limitation, an exclusive hardware chip for an AI, manufactured as a part of an existing general-use processor (e.g., a CPU or an application processor), a graphic exclusive processor (e.g., a GPU), or the like, and may be equipped in various types of electronic devices described above.

In addition, the data acquirer 1320-1, the pre-processor 1320-2, the recognition data selector 1320-3, the recognition result provider 1320-4, and the model updater 1320-5 may be equipped in one electronic device or respectively equipped in individual electronic devices. For example, some of the data acquirer 1320-1, the pre-processor 1320-2, the recognition data selector 1320-3, the recognition result provider 1320-4, and the model updater 1320-5 may be included in an electronic device, and the other some may be included in a server.

At least one of the data acquirer 1320-1, the pre-processor 1320-2, the recognition data selector 1320-3, the recognition result provider 1320-4, or the model updater 1320-5 may be implemented as a software module. When at least one of the data acquirer 1320-1, the pre-processor 1320-2, the recognition data selector 1320-3, the recognition result provider 1320-4, or the model updater 1320-5 is implemented as a software module (or a program module including instructions), the software module may be stored in a non-transitory computer-readable recording medium. In addition, in this case, at least one software module may be provided by an OS or a certain application. A part of the at least one software module may be provided by the OS, and the other part may be provided by the certain application.

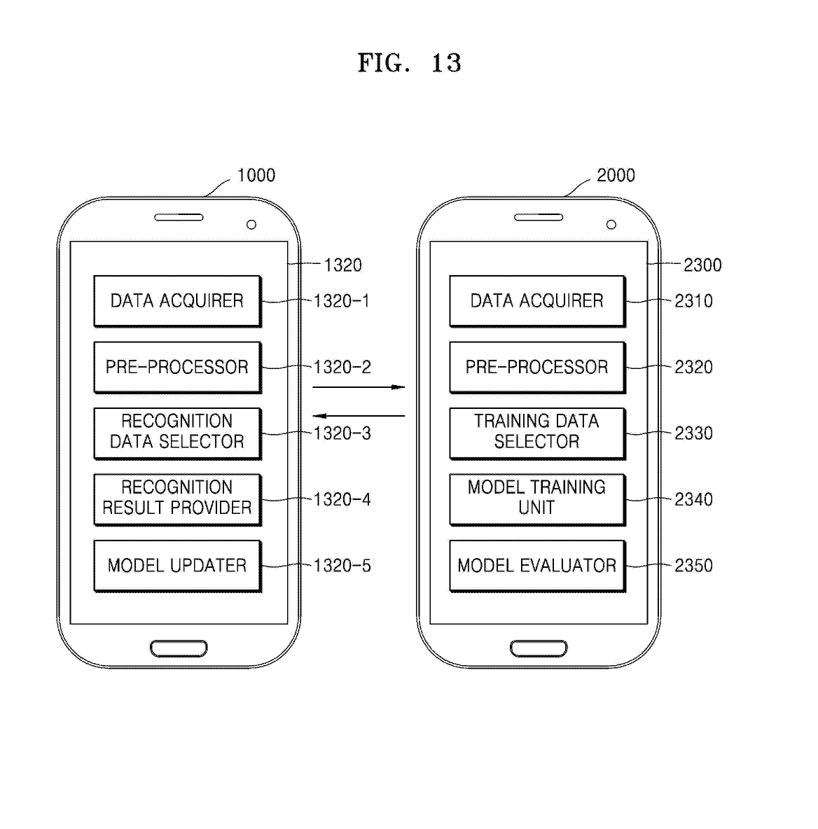

FIG. 13 is a diagram illustrating example training and recognition of data according to linking between the first electronic device 1000 and the second electronic device 2000, according to an embodiment of the disclosure.

Referring to FIG. 13, the second electronic device 2000 may train a reference for determining a context, and the first electronic device 1000 may determine a context based on a result of the training by the second electronic device 2000. The various elements of the data training unit 2300 (e.g., data acquirer 2310, pre-processor 2320, training data selector 2330, model training unit 2340 and model evaluator 2350) may be the same as or similar to like named elements of the data training unit 1310 illustrated in FIG. 11, and as such, repeated descriptions of these elements may not be repeated here.

In this example, a model training unit 2340 of the second electronic device 2000 may perform the function of the model training unit 1310 shown in FIG. 11. The model training unit 2340 of the second electronic device 2000 may train a reference of which data is to be used to determine a certain context and a reference of how to determine a context by using the data. The model training unit 2340 may acquire data to be used for the training, and train a reference for determining a context by applying the acquired data to a neural network model to be described below.

In addition, the recognition result provider 1320-4 of the first electronic device 1000 may determine a context by applying data selected by the recognition data selector 1320-3 to a neural network model generated by the second electronic device 2000. According to an embodiment of the disclosure, the recognition result provider 1320-4 may process the data selected by the recognition data selector 1320-3 by inputting the data selected by the recognition data selector 1320-3 to a first group in the neural network model and transmit a value output from the first group to the second electronic device 2000. In addition, the second electronic device 2000 may determine a context in response to a request from the recognition result provider 1320-4 by inputting the value output from the first group to a second group in the neural network. In addition, the recognition result provider 1320-4 may receive, from the second electronic device 2000, information on a context determined by the second electronic device 2000.

The recognition result provider 1320-4 of the first electronic device 1000 may receive the neural network model generated by the second electronic device 2000 from the second electronic device 2000, and determine a context using the received neural network model. In this case, the recognition result provider 1320-4 of the first electronic device 1000 may determine a context by applying the data selected by the recognition data selector 1320-3 to the neural network model received from the second electronic device 2000.

According to an embodiment of the disclosure, a case in which raw data including important information is transmitted to another device as it is without being transformed may be prevented and/or reduced, and thus, an exposure risk of the important information in a transmission process may be reduced.

Some embodiments of the disclosure may be implemented in a form of a recording medium including computer-executable instructions such as a program module executed by a computer system. A non-transitory computer-readable medium may be an arbitrary available medium which may be accessed by a computer system and includes all types of volatile and non-volatile media and separated and non-separated media. In addition, the non-transitory computer-readable medium may include all types of computer storage media and communication media. The computer storage media include all types of volatile and non-volatile and separated and non-separated media implemented by an arbitrary method or technique for storing information such as computer-readable instructions, a data structure, a program module, or other data. The communication media typically include computer-readable instructions, a data structure, a program module, other data of a modulated signal such as a carrier, other transmission mechanism, and arbitrary information delivery media.

In addition, in the present disclosure, “unit, interface, or -er(or)” may refer, for example, to a hardware component such as a processor or a circuit and/or a software component executed by a hardware component such as a processor or any combinations thereof.

The embodiments of the disclosure described above are merely illustrative, and it will be understood by those of ordinary skill in the art that various changes in form and details may be made therein without changing the technical spirit and scope of the disclosure. Therefore, the various example embodiments of the disclosure should be understood in the illustrative sense only and not for the purpose of limitation in any aspect. For example, each component described as a single type may be carried out by being distributed, and likewise, components described as a distributed type may also be carried out by being coupled.

It should be understood that various example embodiments of the disclosure described herein should be considered in a descriptive sense only and not for purposes of limitation. Descriptions of features or aspects within each embodiment of the disclosure should typically be considered as available for other similar features or aspects in other embodiments of the disclosure.

While one or more example embodiments of the disclosure have been described with reference to the figures, it will be understood by those of ordinary skill in the art that various changes in form and details may be made therein without departing from the spirit and scope as defined, for example, by the following claims and their equivalents.

What is claimed is:

1. A method, performed by a first electronic device, of processing a neural network model, the method comprising:
acquiring an input value of the neural network model;
processing at least one node included in a first group in the neural network model based on the input value;
acquiring at least one value output from the first group by processing the at least one node included in the first group;
identifying a second electronic device by which at least one node included in a second group in the neural network model is to be processed; and
transmitting the at least one value output from the first group to the identified second electronic device.

2. The method of claim 1, wherein the transmitting of the at least one value output from the first group comprises:
acquiring at least one weight corresponding to the at least one value based on the neural network model;
applying the acquired at least one weight to the at least one value; and
transmitting, to the second electronic device, the at least one value to which the at least one weight has been applied.

3. The method of claim 1, wherein the processing of the at least one node included in the first group in the neural network model comprises:
acquiring information about the first group in the neural network model, the information being determined based on at least one of: a data transmission rate between the first electronic device and the second electronic device, a size of the at least one value to be transmitted from the first electronic device to the second electronic device, and computation capabilities of the first electronic device and the second electronic device; and
processing the at least one node included in the first group based on the acquired information.

4. The method of claim 1, wherein the first electronic device and the second electronic device are a terminal device and a server, respectively.

5. A method, performed by a second electronic device, of processing a neural network model, the method comprising:
receiving, from a first electronic device, at least one value output from a first group in the neural network model, the at least one value being obtained by processing at least one node included in the first group;
acquiring at least one node included in a second group in the neural network model; and
processing the at least one node included in the second group based on the received at least one value.

6. The method of claim 5, further comprising:
acquiring an output value output from an output layer in the neural network model by processing the at least one node included in the second group in the neural network model; and
transmitting the acquired output value to the first electronic device.

7. The method of claim 5, wherein the processing of the at least one node included in the second group based on the received at least one value comprises:
acquiring information about the second group in the neural network model, the information being determined based on at least one of: a data transmission rate between the first electronic device and the second electronic device, a size of the at least one value transmitted from the first electronic device to the second electronic device, and computation capabilities of the first electronic device and the second electronic device; and
processing the at least one node included in the second group based on the acquired information.

8. A first electronic device comprising:
a memory;
a communication interface comprising communication circuitry; and
a processor configured to control the first electronic device to: acquire an input value of a neural network model, the input value being stored in the memory, process at least one node included in a first group in the neural network model based on the input value, acquire at least one value output from the first group by processing the at least one node included in the first group, identify a second electronic device by which at least one node included in a second group in the neural network model is to be processed, and control the communication interface to transmit the at least one value output from the first group to the identified second electronic device.

9. The first electronic device of claim 8, wherein the processor is further configured to control the first electronic device to: acquire at least one weight corresponding to the at least one value based on the neural network model, apply the acquired at least one weight to the at least one value, and control the communication interface to transmit, to the second electronic device, the at least one value to which the at least one weight is applied.

10. The first electronic device of claim 8, wherein the processor is further configured to control the first electronic device to: acquire information about the first group in the neural network model, the information being determined based on at least one of: a data transmission rate between the first electronic device and the second electronic device, a size of the at least one value to be transmitted from the first electronic device to the second electronic device, and computation capabilities of the first electronic device and the second electronic device, and process the at least one node included in the first group based on the acquired information.

11. The first electronic device of claim 8, wherein the first electronic device and the second electronic device are a terminal device and a server device, respectively.

12. A second electronic device comprising:
a memory;
a communication interface comprising communication circuitry; and
a processor configured to control the communication interface to receive, from a first electronic device, at least one value output from a first group in a neural network model, the at least one value being obtained by processing at least one node included in the first group, to acquire, from the memory, at least one node included in a second group in the neural network model, and to process the at least one node included in the second group, based on the received at least one value.

13. The second electronic device of claim 12, wherein the processor is further configured to acquire an output value output from an output layer in the neural network model by processing the at least one node included in the second group in the neural network model and to control the communication interface to transmit the acquired output value to the first electronic device.

14. The second electronic device of claim 12, wherein the processor is further configured to acquire information about the second group in the neural network model, the information being determined based on at least one of: a data transmission rate between the first electronic device and the second electronic device, a size of the at least one value transmitted from the first electronic device to the second electronic device, and computation capabilities of the first electronic device and the second electronic device, and to process the at least one node included in the second group based on the acquired information.

15. A non-transitory computer-readable recording medium having recorded thereon a program for executing the method of claim 1.

16. A non-transitory computer-readable recording medium having recorded thereon a program for executing the method of claim 5.
